(19) United States
(12) Patent Application Publication
(10) Pub. No.: US 2014/0314656 A1
(43) Pub. Date: Oct. 23, 2014

(54) GRAPHENE PRODUCTION METHODS AND RESULTANT PRODUCTS

(71) Applicant: Chien-Min Sung, Tansui (TW)

(72) Inventor: Chien-Min Sung, Tansui (TW)

(21) Appl. No.: 14/194,614

(22) Filed: Feb. 28, 2014

Related U.S. Application Data
(63) Continuation of application No. 14/099,838, filed on Dec. 6, 2013.
Application No. 14/099,838 is a continuation of application No. 14/025,408, filed on Sep. 12, 2013, now abandoned.
Application No. 14/025,408 is a continuation-in-part of application No. 12/713,004, filed on Feb. 25, 2010.
Application No. 12/713,004 is a continuation-in-part of application No. 12/499,647, filed on Jul. 8, 2009, now abandoned.
(60) Provisional application No. 61/079,064, filed on Jul. 8, 2008.
(60) Provisional application No. 61/145,707, filed on Jan. 19, 2009.

(51) Int. Cl. C01B 31/04

(52) U.S. Cl. CPC C01B 31/0446
USPC 423/448; 422/129

(57) ABSTRACT

The present invention relates to a method of mass production of graphene. In one embodiment, such a method may include providing a high temperature furnace for storing a molten solvent, wherein the high temperature furnace comprises an outlet disposed on the top of the high temperature furnace, and an inlet, providing a carbon source to mix with the molten solvent, precipitating the carbon to form a graphene layer on the surface of the molten solvent under a supersaturated state, and collecting the graphene layer from the outlet.

### PRIORITY DATA

This application is a continuation of U.S. patent application Ser. No. 14/099,838, filed Dec. 6, 2013, which is a continuation of U.S. patent application Ser. No. 14/025,408, filed Sep. 9, 2013, which claims the benefit of Taiwan Patent Application No. 101133285, filed on Sep. 12, 2012. This application is a continuation of U.S. patent application Ser. No. 14/099,838, filed Dec. 6, 2013, which is a continuation of U.S. patent application Ser. No. 14/025,408, filed Sep. 9, 2013, which is also a continuation-in-part of U.S. patent application Ser. No. 12/713,004, filed on Sep. 2, 2010, which is a continuation-in-part of U.S. patent application Ser. No. 12/499,647, filed on Jul. 8, 2009, which claims the benefit of U.S. Provisional Patent Application Ser. No. 61/079,064, filed on Jul. 8, 2008 and U.S. Provisional Patent Application Ser. No. 61/145,707, filed on Jan. 19, 2009, all of which are incorporated herein by reference.

### FIELD OF THE INVENTION

The present invention relates to a method of mass production of graphene, more particularly, to a method for mass-producing highly graphitized graphene.

### BACKGROUND OF THE INVENTION

Graphene is often defined as a one-atom-thick planar sheet of sp²-bonded carbon atoms. In theory, graphene having the perfect hexagonal grid structure can be comprised of multiple layers of graphene stacking and exhibits high electron mobility in the plane of the layer, as well as exceptional thermal conductivity. Graphene has excellent physical properties that can be widely applied for all kinds of devices, so as to enhance the properties such as heat conductivity, electric conductivity, strength and all that therein. However, since physicists separated successfully out the graphene from graphite at the beginning of the new millennium, no effective method for mass-producing highly graphitized graphene has yet been developed. A conventional method of mass production of graphene is to process graphite by high temperature and pressure, so that carbon atoms of the graphite are rearranged for forming a planar-hexagonal grid structure. However, in addition to high cost, such processes have a number of short comings. In general, these processes produce a hexagonal grid structure of graphene that is unable to obtain larger extension along the direction of the graphene plane(La), and is also broken, so that the basal plane separation (d₍₀₀₀₂₎) is also larger than theoretical value, and thus actual physical properties fall short of expected properties.

### SUMMARY OF THE INVENTION

In view of the foregoing, the present inventors recognize the need for graphene production methods that do not require high purity graphite to be used as raw material and can be effective for large scale economic mass-production of highly graphitized graphene.

Accordingly, embodiments of the present invention provide methods of mass production of graphene, which can precipitate carbon atoms on the surface of a molten solvent under a supersaturated state, so that the carbon recomposes to form the graphene. The molten solvent cannot only be used as a solvent for carbon, but also introduce the carbon atoms of graphene to the most stable position of the lattice structure due to its catalytic function, so that the produced graphene can obtain the maximize degree of stacking, and then highly graphitized graphene can be produced.

In one aspect the present invention provides methods, systems, and devices of mass production of graphene, which can comprise: providing a high temperature furnace for storing a molten solvent, wherein the high temperature furnace comprises an outlet disposed on the top of the high temperature furnace, and an inlet; providing a carbon source to mix with the molten solvent; precipitating carbon atoms of the carbon source to form a graphene layer on the surface of the molten solvent under a supersaturated state; and collecting the graphene layer from the outlet, wherein, the high temperature furnace further comprises a feed apparatus connected with the inlet, so as to mix the carbon source in the molten solvent. The inlet may be disposed on the different position relative to the high temperature furnace based on variety of the carbon source. For example, in one aspect, the inlet may be disposed on the bottom of the high temperature furnace, and the carbon source may be input from the inlet of the bottom of the high temperature furnace, so that the material of the carbon source may be optimally mixed with the molten solvent. In addition, when the carbon source gas is input from the inlet of the bottom of the high temperature furnace, the convection in the molten solvent can be driven simultaneously, so that the carbon source is well mixed with the molten solvent, and the production capacity of graphene may be improved. In another aspect, when the carbon source is solid of which material and size may be not uniform, a solid carbon source can be added into the inlet disposed on the top of the high temperature furnace, and the inlet can be the same or different with the outlet under the requirement. In the other aspect, for controlling a state of turbulence of the molten solvent or recrystallizing the highly graphitized of graphene, these desires can be also achieved by adding the carbon source into the inlet disposed on the sides of the high temperature furnace. However, the disposed position of the above-mentioned inlet is only illustrative of an example of the application of the present invention, and the method of mass production of graphene of the present invention can be designed as a batch collection mode or a continuous collection mode, but not limited thereto.

In order to make production, or mass production, of graphene having the highly graphitized of crystal structure, as mentioned above, it is desirable to control the temperature of the molten solvent in the high temperature furnace. Therefore, in the present invention, the high temperature furnace may further comprise a temperature controller. In one aspect of the present invention, the temperature of the molten solvent may be controlled by an electric furnace, so that the temperature of the molten solvent may exhibit a gradient distribution or a uniform distribution, but not limited thereto.

As mentioned above, when the carbon atoms of the carbon source are precipitated in the molten solvent under the supersaturated state, the precipitated carbon atoms will be rearranged to form a graphene layer on the surface of the molten solvent because the density of carbon atoms is lower than the density of the molten solvent. Consequently, the outlet of the present invention may be disposed on the top of the high temperature furnace. Furthermore, in order to achieve the object of mass production, the present invention may further comprise a graphene collection apparatus disposed on the top of the high temperature furnace. According to one aspect of the present invention, the graphene collection apparatus may be a batch collection apparatus collecting the produced graphene layer by a discontinuous means. Moreover, in the present invention, the molten solvent is used as a solvent and a catalyst, so that the molten solvent is not consumed during the process. Therefore, in another aspect of the present invention, the produced graphene layer may be continually collected by a continuous collection apparatus.

In one aspect of the present invention, the molten solvent may be at least one selected from the group consisting of ferrous (Fe), cobalt (Co), nickel (Ni), tantalum (Ta), palladium (Pd), platinum (Pt), lanthanum (La), cerium (Ce), Europium (Eu) and an alloy thereof. In one specific aspect, the molten solvent may comprise Fe, Co, Ni, or an alloy thereof. In another specific aspect, the molten solvent may further comprise other element, so as to decrease reactivity. For example, in one aspect, the molten solvent may comprise a compound with low activity for decreasing the activity of the molten solvent. Any material to decrease the activity of the molten solvent may be utilized, but not limited thereto. However, in one specific aspect, the compound with low activity may be gold (Au), silver (Ag), copper (Cu), lead (Pb), zinc (Zn) or an alloy thereof.

In the present invention, the carbon source can be any material containing carbon of which state may be gas, liquid, or solid, or a combination thereof, but not limited thereto. For example, in one aspect of the present invention, gas material may be used as the carbon source, and any carbon containing gas may be used. For example, in the present invention, the carbon source gas may be at least one selected from the group consisting of pyrolysis gasoline (PYGAS), hydrocarbon, water-gas or a combination thereof. In one specific aspect, the carbon source gas may be PYGAS, water-gas or a combination thereof. In another aspect of the present invention, solid material may be used as the carbon source. As mentioned above, any solid containing carbon can be utilized, but not limited thereto. For example, in one aspect of the present invention, the solid carbon source may be at least one selected from the group consisting of plastic, rubber, carbohydrate, bitumen, gasoline, carbon black, graphite, hydrocarbon or a combination thereof. However, it is noted that when the carbon containing gas is chosen as the carbon source, the amount of the carbon in the molten solvent may decrease due to the carbon dioxide easily formed from oxygen and carbon in the high temperature furnace, so that the yield may drop. Accordingly, in one aspect of the present invention, the feeding apparatus may further comprise a deoxidizing apparatus, which may be used to deoxidize the chosen carbon source gas, so as to avoid the above-mentioned situation. According to the composition of the chosen carbon source gas, any deoxidizing means may be utilized, but not limited thereto.

Another aspect of the present invention is to provide an apparatus of production, or mass production, of graphene, which may precipitate carbon atoms on the surface of a molten solvent under a supersaturated state, so that the carbon may recompose to form the graphene. The molten solvent cannot only be used as a solvent for carbon, but also introduce the carbon atoms of graphene to the most stable position of the lattice structure due to its catalytic function, so that the produced graphene can obtain the maximize degree of stacking, and then highly graphitized graphene can be produced.

To achieve the above-mentioned aspect, the present invention provides an apparatus of production, or mass production, of graphene, which comprises: a high temperature furnace for storing a molten solvent, wherein the high temperature furnace may comprise an outlet disposed on the top of the high temperature furnace, and an inlet; a feed apparatus, is connected with the inlet, so as to mix a carbon source in the molten solvent. The inlet may be disposed on the different position relative to the high temperature furnace based on a variety of the carbon source. For example, in one aspect, the inlet may be disposed on the bottom of the high temperature furnace, and the carbon source may be input from the inlet of the bottom of the high temperature furnace, so that the material of the carbon source may be optimally mixed with the molten solvent. In addition, when the carbon source gas is input from the inlet of the bottom of the high temperature furnace, the convection in the molten solvent may be driven simultaneously, so that the carbon source is well mixed with the molten solvent, and the production capacity of graphene may be improved. In another aspect, when the carbon source is solid of which material and size may be not uniform, a solid carbon source may be added into the inlet disposed on the top of the high temperature furnace, and the inlet may be the same or different with the outlet under the requirement. In the other aspect, for controlling a state of turbulence of the molten solvent or recrystallizing the highly graphitized graphene, these desires may be also achieved by adding the carbon source into the inlet disposed on the sides of the high temperature furnace. However, the disposed position of the above-mentioned inlet is only illustrative of the application of the present invention, and the apparatus of mass production of graphene of the present invention may be designed as a batch collection mode or a continuous collection mode, but not limited thereto.

In order to make mass production of graphene having the highly graphitized crystal structure, as mentioned above, it is important to control the temperature of the molten solvent in the high temperature furnace. Therefore, in the present invention, the high temperature furnace may further comprise a temperature controller. In one aspect of the present invention, the temperature of the molten solvent may be controlled by an electric furnace, so that the temperature of the molten solvent may exhibit a gradient distribution or a uniform distribution, but not limited thereto.

As mentioned above, when the carbon atoms of the carbon source are precipitated in the molten solvent under the supersaturated state, the precipitated carbon atoms will be rearranged to form a graphene layer on the surface of the molten solvent because the density of carbon atoms is lower than the density of the molten solvent. Consequently, the outlet of the present invention may be disposed on the top of the high temperature furnace. Furthermore, in order to achieve the object of mass production, the present invention may further comprise a graphene collection apparatus disposed on the top of the high temperature furnace. According to one aspect of the present invention, the graphene collection apparatus may be a batch collection apparatus collecting the produced graphene layer by a discontinuous means. Moreover, in the present invention, the molten solvent is used as a solvent and a catalyst, so that the molten solvent is not consumed in the process. Therefore, in another aspect of the present invention, the produced graphene layer may be continually collected by a continuous collection apparatus.

In one aspect of the present invention, the molten solvent may be at least one selected from the group consisting of ferrous (Fe), cobalt (Co), nickel (Ni), tantalum (Ta), palladium (Pd), platinum (Pt), lanthanum (La), cerium (Ce), Europium (Eu) and an alloy thereof. In one specific aspect, the molten solvent comprises Fe, Co, Ni, or an alloy of thereof. In another specific aspect, the molten solvent may further comprise other element, so as to decrease reactivity. For example, in one aspect, the molten solvent may comprise a compound with low activity for decreasing the activity of the molten solvent. Any material to decrease the activity of the molten solvent may be utilized, but not limited thereto. However, in one specific aspect, the compound with low activity may be gold (Au), silver (Ag), copper (Cu), lead (Pb), zinc (Zn) or an alloy or a combination thereof.

In the present invention, the carbon source can be any material containing carbon of which state can be gas, liquid, or solid, but not limited thereto. For example, in one aspect of the present invention, gas material may be used as the carbon source, and any carbon containing gas may be used. For example, in the present invention, the carbon source gas may be at least one selected from the group consisting of pyrolysis gasoline (PYGAS), hydrocarbon, water-gas or a combination thereof. In one specific aspect, the carbon source gas may be PYGAS, water-gas or a combination thereof. Furthermore, in another aspect of the present invention, solid material may be used as the carbon source. As mentioned above, any solid containing carbon can be utilized, but not limited thereto. For example, in one aspect of the present invention, the solid carbon source may be at least one selected from the group consisting of plastic, rubber, carbohydrate, bitumen, gasoline, carbon black, graphite, hydrocarbon or combinations thereof. However, it is noted that when the carbon containing gas is chosen as the carbon source, the amount of the carbon in the molten solvent may decrease due to the carbon dioxide easily formed from oxygen and carbon in the high temperature furnace, so that the yield may drop. Accordingly, in one aspect of the present invention, the feeding apparatus may further comprise a deoxidizing apparatus, which may be used to deoxidize the chosen carbon source gas, so as to avoid the above-mentioned situation. According to the composition of the chosen carbon source gas, any deoxidizing means may be utilized, but not limited thereto.

There has thus been outlined, rather broadly, various features of the invention so that the detailed description thereof that follows may be better understood, and so that the present contribution to the art may be better appreciated. Other features of the present invention will become clearer from the following detailed description of the invention, taken with the accompanying claims, or may be learned by the practice of the invention.

### BRIEF DESCRIPTION OF THE DRAWINGS

FIG. 1 is a schematic view of mass production of graphene according to the first and second embodiments of the present invention;

FIG. 2 is a schematic view of mass production of graphene according to the third embodiment of the present invention;

FIG. 3 is a schematic view of mass production of graphene according to the fourth embodiment of the present invention;

FIG. 4 is a schematic view of mass production of graphene according to the fifth embodiment of the present invention; and

FIG. 5 is a schematic view of mass production of graphene according to the sixth embodiment of the present invention.

### DETAILED DESCRIPTION OF THE PREFERRED EMBODIMENT

Although the following detailed description contains many specifics for the purposes of illustration, a person of ordinary skill in the art will appreciate that many variations and alterations to the following details can be made and are considered to be included herein.

Accordingly, the following embodiments are set forth without any loss of generality to, and without imposing limitations upon, any claims set forth. It is also to be understood that the terminology used herein is for the purpose of describing particular embodiments only, and is not intended to be limiting. Unless defined otherwise, all technical and scientific terms used herein have the same meaning as commonly understood by one of ordinary skill in the art to which this disclosure belongs.

As used in this specification and the appended claims, the singular forms “a,” “an” and “the” include plural referents unless the context clearly dictates otherwise. Thus, for example, reference to “a layer” includes a plurality of such layers.

In this content, “degree of graphitization” refers to the proportion of graphite. The theoretical value of the distance between graphene planes is 3.354 angstroms. Thus, when a degree of graphitization of 1 indicates the most compacted stacking graphene layer, the graphene planes have basal plane separation (d(0002)) of 3.354 angstroms. The degree of graphitization, G, can be calculated using Equation 1:

G=(3.440−d(0002))/(3.440−3.354) (1)

Accordingly, a higher degree of graphitization corresponds to larger crystallite sizes, which are characterized by the size of the basal planes (La) and size of stacking layers (Lc) of graphene planes having the structure of hexagonal network of carbon atoms. Therefore, the “higher degree of graphitization” (or “highly graphitized”) typically indicates a degree of graphitization greater than 0.8. However, the degree of graphitization of the graphene layer mass-produced by the apparatus of the invention may be greater than 0.85. In some specific aspects, the degree of graphitization may be achieved from about 0.9 to about 1, or from 0.9 to 1.

As used herein, the term “carbon source” indicates any material containing carbon, which may be gas, liquid or solid, or combination or mixture there. Furthermore, composition of the material also may be pure material, chemical compound, or mixture, but not limited thereto.

As used herein, the term “molten solvent” indicates a metal or an alloy is heated to form a molten state so as to be used as a solvent for carbon.

As used herein, the term “graphene” or “graphene layer” includes reference to both single atom layer of graphene and multiple layer stacks of graphene.

As used herein, “comprises,” “comprising,” “containing” and “having” and the like can have the meaning ascribed to them in U.S. Patent law and can mean “includes,” “including,” and the like, and are generally interpreted to be open ended terms. The terms “consisting of” or “consists of” are closed terms, and include only the components, structures, steps, or the like specifically listed in conjunction with such terms, as well as that which is in accordance with U.S. Patent law. “Consisting essentially of” or “consists essentially of” have the meaning generally ascribed to them by U.S. Patent law. In particular, such terms are generally closed terms, with the exception of allowing inclusion of additional items, materials, components, steps, or elements, that do not materially affect the basic and novel characteristics or function of the item(s) used in connection therewith. For example, trace elements present in a composition, but not affecting the compositions nature or characteristics would be permissible if present under the “consisting essentially of” language, even though not expressly recited in a list of items following such terminology. When using an open ended term, like “comprising” or “including,” it is understood that direct support should be afforded also to “consisting essentially of” language as well as “consisting of” language as if stated explicitly.

“The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments described herein are, for example, capable of operation in other orientations than those illustrated or otherwise described herein. The term “coupled,” as used herein, is defined as directly or indirectly connected in an electrical or nonelectrical manner. Objects described herein as being “adjacent to” each other may be in physical contact with each other, in close proximity to each other, or in the same general region or area as each other, as appropriate for the context in which the phrase is used. Occurrences of the phrase “in one embodiment,” or “in one aspect,” herein do not necessarily all refer to the same embodiment or aspect.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, the term “about” is used to provide flexibility to a numerical range endpoint by providing that a given value may be “a little above” or “a little below” the endpoint.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 2, 3, 4, and 5, individually.

This same principle applies to ranges reciting only one numerical value as a minimum or a maximum. Furthermore, such an interpretation should apply regardless of the breadth of the range or the characteristics being described.

Reference throughout this specification to “an example” means that a particular feature, structure, or characteristic described in connection with the example is included in at least one embodiment. Thus, appearances of the phrases “in an example” in various places throughout this specification are not necessarily all referring to the same embodiment.

The present invention relates to methods of mass production of graphene, more particularly, to a method for mass producing highly graphitized graphene. It has been considered that a molten solvent, such as a metal solvent can be used as a metal catalyst so as to increase the degree of graphitization. Embodiments of the present invention further expand the use of such solvents as a part of a production, or mass production, of graphene. In some embodiments, the method of does not require high purity graphite to be used as a carbon source, and the graphene formed is precipitated from the molten solvent and then floats on the surface of the molten solvent, so as to collect graphene by all kind of convenient mechanisms.

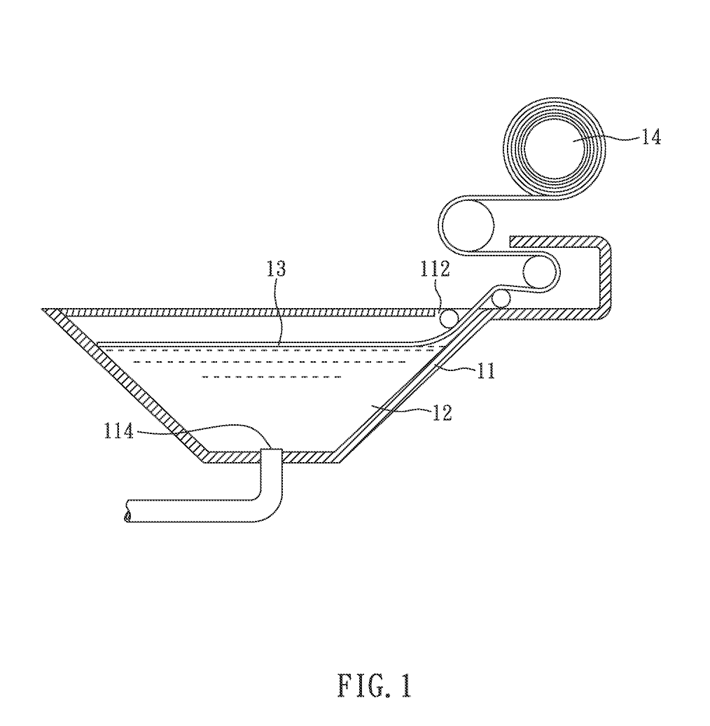

Referring to FIG. 1, which is a schematic view of an apparatus of mass production of graphene according to the first and second embodiments of the present invention, which comprise: a high temperature furnace 11 for storing a molten solvent 12, wherein the high temperature furnace 11 comprises an outlet 112 disposed on the top of the high temperature furnace 11, and an inlet 114 on the bottom of the high temperature furnace 11. In the first embodiment, the carbon source is water-gas, which is a mixed gas consisted of carbon monoxide (CO) and hydrogen (H₂). When the water-gas is input from the inlet 114 of the bottom of the high temperature furnace, the convection in the molten solvent can be driven simultaneously, so that the carbon source is well mixed with the molten solvent 12. In the first embodiment, the molten solvent 12 is nickel-cerium alloy, which has a melt point 600° C., and is adapted for precipitating carbons under a supersaturated state to form a graphene layer 13. Accordingly, after the water-gas is input in the high temperature furnace 11, it can avoid oozing the molten solvent 12 from the inlet 114 of the bottom of the high temperature furnace 11 via controlling a one-way valve (not shown in FIG. 1). After carbon monoxide and hydrogen of the water-gas precipitate carbon atoms by Reaction 1, the carbon atoms are precipitated on the surface of the molten solvent 12 under the supersaturated state due to a difference of specific weight between the carbon atoms and the molten solvent 12, so as to recompose to form a graphene layer 13, at this time, and then the graphene layer 13 can be retrieved in batches by a graphene collector 14.

CO+H₂→C+H₂O Reaction 1

However, Reaction 1 is an endothermic reaction. If heat is not provided by other heat source, the temperature of the molten solvent 12 lower than its melting point due to the precipitation of the carbon atoms, so that the molten solvent 12 in the high temperature furnace 11 may result in solidification. Therefore, the first embodiment of the present invention cannot input a plenty of water-gas to mass-produce the graphene. Accordingly, the second embodiment of the present invention is to provide a method of raising batch production of graphene. Referring again to FIG. 1, the apparatus according to the second embodiment is almost the same as that of the first embodiment, except that when the water gas is input, a small amount of air (Volume ratio 9:1 is between the water-gas and the air.) is also input simultaneously, so that a part of hydrogen in the water-gas may react with oxygen of the air to form water vapor, as shown Reaction 2. Reaction 2 is an exothermic reaction, and the generated reactive heat is used as a heat source, so that the molten solvent 12 can be maintained the temperature above 600° C. without congealing. Furthermore, the inlet 114 is disposed on the bottom of the high temperature furnace 11, so that the temperature of the molten solvent 12 lied near the bottom of the high temperature furnace 11 is higher than the temperature of the molten solvent 12 lied near the top of the high temperature furnace 11 due to the reaction heat, and thus the molten solvent 12 performs a temperature gradient. Therefore, the carbon atoms generated by Reaction 1 are easily to dissolve in the molten solvent 12 of the bottom of the high temperature furnace 11 and to precipitate on the surface of the molten solvent 12 of the top of the high temperature furnace 11, so that it is benefits to mass-produce the graphene layer 13.

Accordingly, as shown FIG. 1, the apparatus of mass production of graphene in the first and second embodiments, which comprises: a high temperature furnace 11 for storing a molten solvent 12, wherein the high temperature furnace 11 comprises an outlet 112 disposed on the top of the high temperature furnace 11, and an inlet 114 disposed on the bottom of the high temperature furnace 11; and a graphene collector 14 disposed on the outlet 112 of the high temperature furnace 11.

H₂+O₂→2H₂O Reaction 2

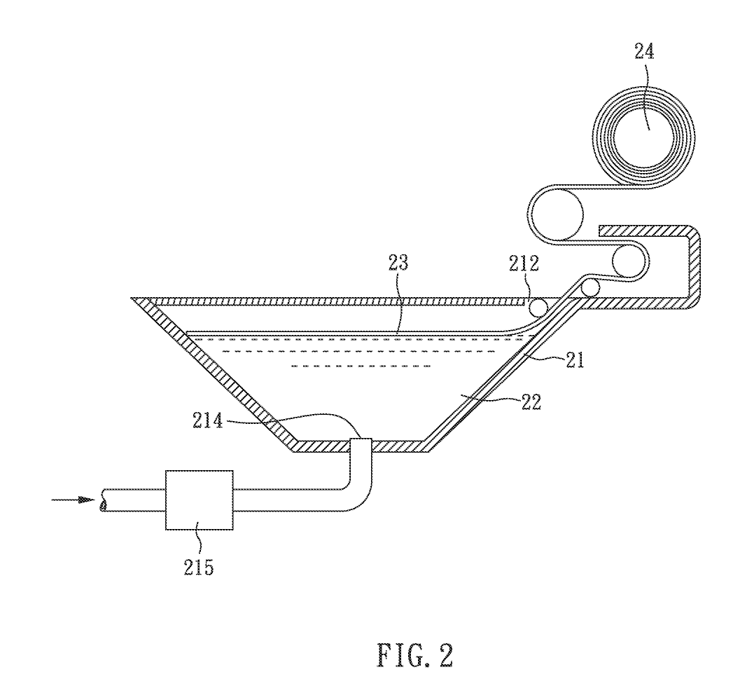

Referring to FIG. 2, which is a schematic view of an apparatus of mass production of graphene according to the third embodiment of the present invention. The apparatus according to the third embodiment is almost the same as that of the first embodiment, except that the apparatus further comprises a pump used as a feeding apparatus 215 for regulating the air inflow of the water-gas, so as to achieve to continuously mass-produce a graphene layer 23. Accordingly, when the amount of the carbon atoms in the molten solvent 22 is lower than its saturated concentration therein due to the precipitation of the carbon atoms on the surface of the molten solvent 22, the feeding apparatus 215 can input the water-gas to supplement the amount of the carbon atoms in the molten solvent 22, so as to achieve the object of continuous mass production of the graphene. Similarly, in the present embodiment, a small amount of air (Volume ratio 9:1 is between the water-gas and the air.) can be input when the water-gas is input for regulating the temperature of the molten solvent. In addition, the gas pressure input in the high temperature furnace 22 can be regulated by the feeding apparatus 215, so that the effect of stirring the molten solvent 22 can be achieved. If the degree of graphitization of the produced graphene layer 23 is poor, the molten solvent can be strongly stirred by raising the gas pressure, so that the precipitated graphene can be dissolved into the molten solvent 22. Then, the high degree of graphitization of the graphene layer 23 can be precipitated again.

Accordingly, as shown FIG. 2, the third embodiment provides an apparatus of mass production of graphene, which comprises: a high temperature furnace 21 for storing a molten solvent 22, wherein the high temperature furnace 21 comprises an outlet 212 disposed on the top of the high temperature furnace 21, and an inlet 214 disposed on the bottom of the high temperature furnace 21; a graphene collector 24 disposed on the outlet 212; and a feeding apparatus 215 disposed in front of the inlet 214.

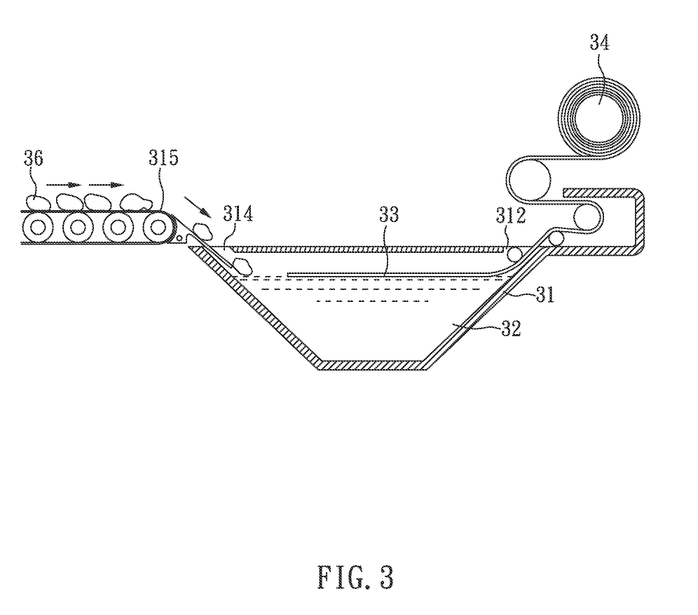

Referring to FIG. 3, which is a schematic view of an apparatus of mass production of graphene according to the fourth embodiment of the present invention. In the present embodiment, a flood-wood is used to be a solid carbon source 36 for providing to the apparatus of mass production of graphene and a nickel-ferrous alloy which has a melting point 1300° C., is used to be a molten solvent 32. In the present embodiment, an outlet 312 and an inlet 314 of a high temperature furnace 31 is both disposed on the top of the high temperature furnace 31. Thus, in the present embodiment, the solid carbon source 36 consisted of the flood-wood is added to the high temperature furnace 31 from the inlet 314, and then carbon atoms of the solid carbon source 36 consisted of the flood-wood is precipitated to form a graphene layer 33 on the surface of the molten solvent 32. After that, the graphene layer 33 is collected by a batch collection apparatus 34.

Accordingly, as shown FIG. 3, the fourth embodiment provides an apparatus of mass production of graphene, which comprises: a high temperature furnace 31 for storing a molten solvent 32, wherein the high temperature furnace 31 comprises an inlet 314 and an outlet 312 disposed on the top of the high temperature furnace 31; a graphene collector 34 disposed on the outlet 312; and a feeding apparatus 315 disposed on the inlet 314.

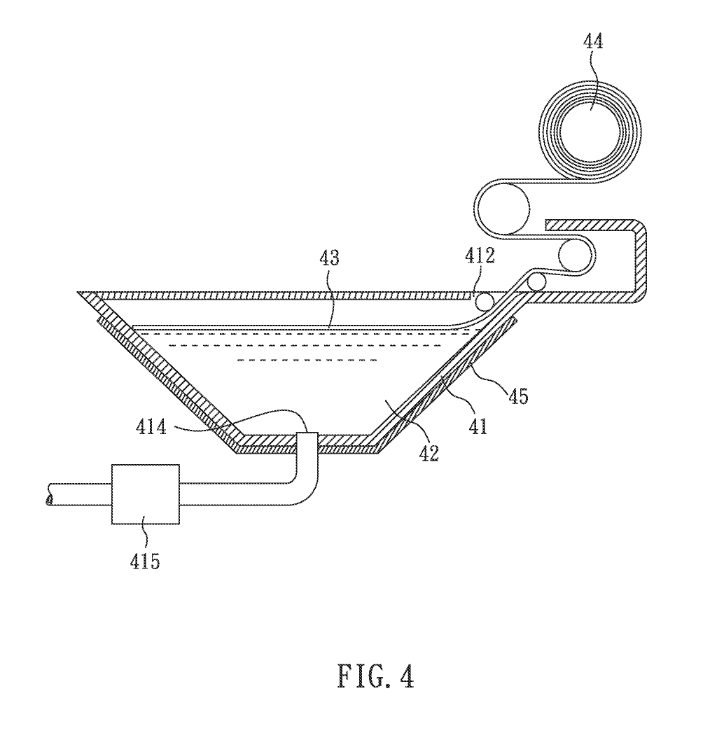

Referring to FIG. 4, which is a schematic view of an apparatus of mass production of graphene according to the fifth embodiment of the present invention. The apparatus according to the present embodiment is similar to that of the third embodiment, except that the used carbon source is organic hydrocarbon gas generated by petroleum cracking process, wherein the organic hydrocarbon gas comprises methane, ethane or analog thereof. Accordingly, when the organic hydrocarbon gas is input from the inlet 414 of the bottom of the high temperature furnace, the carbon atoms are precipitated on the surface of a molten solvent by Reaction 3 or Reaction 4 for forming a graphene layer 43. Because both of Reactions 3 and 4 are endothermic reducing reaction, the temperature of the molten solvent would be lower than 600° C. due to a continuous input of the organic hydrocarbon gas. Therefore, the present embodiment further comprises a temperature controller 45, which is used to control the temperature of the molten solvent 42 of the present embodiment. In the present embodiment, the temperature controller 45 is a resistance furnace disposed on the outside of the high temperature furnace, so as to maintain the temperature of the molten solvent above about 600° C.

Accordingly, as shown FIG. 4, the fifth embodiment provides an apparatus of mass production of graphene, which comprises: a high temperature furnace 41 for storing a molten solvent 42, wherein the high temperature furnace 41 comprises an outlet 412 disposed on the top of the high temperature furnace 41, and an inlet 414 disposed on the bottom of the high temperature furnace 41; a graphene collector 44 disposed on the outlet 412; a feeding apparatus 415 disposed in front of the inlet 414; and a temperature controller 45 for maintain the temperature of the molten solvent.

CH₄→C+2H₂ Reaction 3

C₂H₆→2C+3H₂ Reaction 4

Reaction 3 and Reaction 4 respectively use methane and ethane to represent the precipitation of carbon atoms, but not limited to, other organic hydrocarbon gas can be also used as a carbon source gas.

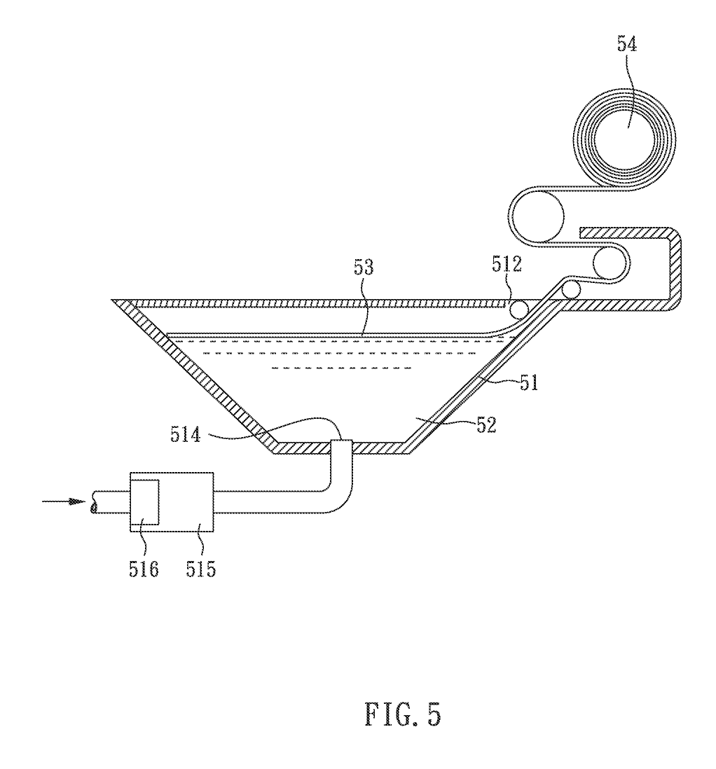

Referring to FIG. 5, which is a schematic view of an apparatus of mass production of graphene according to the sixth embodiment of the present invention. The apparatus according to the present embodiment is similar to that of the third embodiment, except that the present embodiment further comprises a deoxidizing apparatus 516 disposed in front of a feeding apparatus 515. In above-mentioned embodiments, although the reaction heat generated by air and hydrogen can maintain the temperature of the molten solvent, the precipitated carbon atoms would be oxidized into carbon dioxide due to the excess oxygen. Then, carbon dioxide would dissipate in the air. Accordingly, the present embodiment disposes a deoxidizing apparatus 516 in front of a feeding apparatus 515 to regulate the oxygen content into the high temperature furnace 51, so as to control the temperature of a molten solvent 42 and avoid oxidizing excessively the precipitated carbon atoms. In the present embodiment, the oxygen content of the water-gas containing oxygen can be regulated by the deoxidizing apparatus 516. After that, the water-gas containing oxygen is input into the high temperature furnace 51 by the feeding apparatus 515, and carries on the reactions in the molten solvent 52 as above-mentioned Reaction 1 and Reaction 2. Thus, the formation of the graphene layer 53 on the surface of the molten solvent 52 and the maintenance of the temperature of the molten solvent 52 above 600° C. can be achieved at the same time. In particular, the temperature of the molten solvent 52 lied near the bottom of the high temperature furnace 51 is higher and the temperature of the molten solvent 12 lied near the top of the high temperature furnace 11 is lower, so that the molten solvent 52 exhibits a temperature gradient for advantageously precipitating the dissolved carbon atoms to form the graphene layer 53. Furthermore, please refer to FIG. 5, and also refer to FIG. 4, even though FIG. 5 does not show a temperature controller, the resistance furnace used in the fifth embodiment and the deoxidizing apparatus 516 can be used together in the present embodiment. Therefore, the temperature distribution of the molten solvent 52 can be controlled effectively to mass-produce continuously the graphene.

Accordingly, as shown FIG. 5, the sixth embodiment provides an apparatus of mass production of graphene, which comprises: a high temperature furnace 51 for storing a molten solvent 52, wherein the high temperature furnace 51 comprises an outlet 512 disposed on the top of the high temperature furnace 51, and an inlet 514 disposed on the bottom of the high temperature furnace 51; a graphene collector 54 disposed on the outlet 512; a feeding apparatus 515 disposed in front of the inlet 514; and a deoxidizing apparatus 516 for regulating the oxygen content of the carbon source gas.

It is to be understood that the above-described arrangements are only illustrative of the application of the principles of the present invention. Numerous modifications and alternative arrangements may be devised by those skilled in the art without departing from the spirit and scope of the present invention and the appended claims are intended to cover such modifications and arrangements. Thus, while the present invention has been described above with particularity and detail in connection with what is presently deemed to be the most practical and preferred embodiments of the invention, it will be apparent to those of ordinary skill in the art that numerous modifications, including, but not limited to, variations in size, materials, shape, form, function and manner of operation, assembly and use may be made without departing from the principles and concepts set forth herein.

What is claimed is:

1. A method of mass production of graphene, which comprises:
providing a high temperature furnace for storing a molten solvent, wherein the high temperature furnace comprises an outlet disposed on the top of the high temperature furnace, and an inlet;
providing a carbon source to mix with the molten solvent;
precipitating carbon atoms of the carbon source to form a graphene layer on the surface of the molten solvent under a supersaturated state; and
collecting the graphene layer from the outlet.

2. The method of mass production of graphene as claimed in claim 1, wherein the high temperature furnace further comprises a feed apparatus connected with the inlet, so as to mix the carbon source in the molten solvent.

3. The method of mass production of graphene as claimed in claim 1, wherein the inlet is disposed on the top, bottom, sides or a combination thereof of the high temperature furnace.

4. The method of mass production of graphene as claimed in claim 1, wherein the high temperature furnace further comprises a temperature controller.

5. The method of mass production of graphene as claimed in claim 1, wherein the high temperature furnace further comprises a graphene collection apparatus.

6. The method of mass production of graphene as claimed in claim 1, wherein the molten solvent is at least one selected from the group consisting of ferrous (Fe), cobalt (Co), nickel (Ni), tantalum(Ta), palladium (Pd), platinum (Pt), lanthanum (La), cerium (Ce), europium (Eu) and an alloy thereof.

7. The method of mass production of graphene as claimed in claim 5, the molten solvent further comprises gold (Au), silver (Ag), copper (Cu), lead (Pb), zinc (Zn) or an alloy thereof.

8. The method of mass production of graphene as claimed in claim 1, wherein the carbon source is a carbon source gas or a solid carbon source.

9. The method of mass production of graphene as claimed in claim 8, wherein the carbon source gas is at least one selected from the group consisting of pyrolysis gas (PYGAS), hydrocarbon, water-gas or combinations thereof.

10. The method of mass production of graphene as claimed in claim 8, wherein the solid carbon source is at least one selected from the group consisting of plastic, rubber, carbohydrate, bitumen, gasoline, carbon black, graphite, hydrocarbon or combinations thereof.

11. The method of mass production of graphene as claimed in claim 5, wherein the graphene collection apparatus is a batch collection apparatus or a continuous collection apparatus.

12. The method of mass production of graphene as claimed in claim 2, wherein the feeding apparatus further comprises a deoxidizing apparatus.

13. An apparatus of mass production of graphene, which comprises:
a high temperature furnace provided for storing a molten solvent, wherein the high temperature furnace comprises an outlet disposed on the top of the high temperature furnace, and an inlet;
a feed apparatus, is connected with the inlet, so as to mix a carbon source in the molten solvent.

14. The apparatus of mass production of graphene as claimed in claim 13, wherein the inlet is disposed on the top, bottom, sides or combinations thereof of the high temperature furnace

15. The apparatus of mass production of graphene as claimed in claim 13, wherein the high temperature furnace further comprises a temperature controller.

16. The apparatus of mass production of graphene as claimed in claim 13, the high temperature furnace further comprises a graphene collection apparatus.

17. The apparatus of mass production of graphene as claimed in claim 13, wherein the feeding apparatus further comprises a deoxidizing apparatus.

18. The apparatus of mass production of graphene as claimed in claim 13, wherein the molten solvent is at least one selected from the group consisting of ferrous (Fe), cobalt (Co), nickel (Ni), tantalum(Ta), palladium (Pd), platinum (Pt), lanthanum (La), cerium (Ce), Europium (Eu) and an alloy thereof.

19. The apparatus of mass production of graphene as claimed in claim 18, the molten solvent further comprises gold (Au), silver (Ag), copper (Cu), lead (Pb), zinc (Zn) or an alloy thereof.

20. The apparatus of mass production of graphene as claimed in claim 13, wherein the carbon source is a carbon source gas or a solid carbon source.

21. The apparatus of mass production of graphene as claimed in claim 13, wherein the carbon source gas is at least one selected from the group consisting of pyrolysis gasoline (PYGAS), hydrocarbon, water-gas or a combination thereof.

22. The apparatus of mass production of graphene as claimed in claim 13, the solid carbon source is at least one selected from the group consisting of plastic, rubber, carbohydrate, bitumen, gasoline, carbon black, graphite, hydrocarbon or a combination thereof.

23. The apparatus of mass production of graphene as claimed in claim 16, wherein the feeding apparatus further comprises a deoxidizing apparatus.
